(19) United States
(12) Patent Application Publication
(10) Pub. No.: US 2024/0054135 A1
(43) Pub. Date: Feb. 15, 2024

(54) Machine Analysis Of Hydrocarbon Studies

(71) Applicant: ExxonMobil Upstream Research Company, Spring, TX (US)

(72) Inventors: Dennis C. Furlaneto, Spring, TX (US); Scott K. Johnsgard, Spring, TX (US); Brian D. Hughes, Houston, TX (US); Pierre Fillault, The Woodlands, TX (US)

(21) Appl. No.: 17/766,619

(22) PCT Filed: Nov. 4, 2020
(86) PCT No.: PCT/US2020/070746

§ 371 Date: Apr. 5, 2022

Related U.S. Application Data
(60) Provisional application No. 62/934,088, filed on Nov. 12, 2019.

(51) Int. Cl. G06F 16/2457; G06F 16/29

(52) U.S. Cl. CPC G06F 16/24575; G06F 16/29

(57) ABSTRACT

Aspects of the technology described herein make legacy hydrocarbon studies accessible to modern computer analysis. Whatever the initial format, the technology described herein analyzes the studies to identify characteristics that are interesting to people who study hydrocarbon environments. As an initial process, various segments within a hydrocarbon study received by the technology described herein are identified. The various segments can include text, maps, charts, and tables. Within each of these segments, specific types of text segments, maps, charts, and tables may be identified. For each segment identified, characteristics of interest may be determined through analysis of the segment. In one aspect, segment-specific analysis is performed on each type of segment. Different technologies may be used for different segments. Once the characteristics are identified, they may be stored in association with both the overall document and with a segment of the document from which the characteristic of interest was extracted.

### CROSS REFERENCE TO RELATED APPLICATIONS

This application claims the benefit of priority of U.S. Provisional Application No. 62/934,088, filed Nov. 12, 2019, the disclosure of which is incorporated herein by reference in its entirety.

### FIELD

This application relates to automated machine analysis and classification of oil and gas documents and document segments.

### BACKGROUND

Paper documents, such as hydrocarbon studies, may be scanned for viewing on a computer. Once scanned, such documents may be saved to computer storage. Optical character recognition may be performed to make the text of such documents searchable. Keywords from the documents may be added to a lookup index used to return relevant documents in response to a query. However, keyword searching is an imprecise method for the correct study for large amounts of documents covering the same or similar subjects. For example, a group of documents written to describe the same subject is likely to use many of the same words, and even if found, drawing conclusions from dozens or even hundreds of documents still requires an expert to read through a large amount of text, analyze different graphics and potentially interact with many applications, which detracts from the cognitive process of analyzing the most important information and finding new exploration opportunities. Having access to the right information is not equivalent to having access to documents in this context. As highlighted in National Research Council. 2002. Geoscience Data and Collections: National Resources in Peril. Washington, DC: The National Academies Press (https://doi.org/10.17226/10348), geoscience samples and collections come in many forms. Physical evidence such as soil, rocks, and fossils are extremely important for assessing a new area's hydrocarbon potential, and for old assessments, as physical evidence deteriorates or is not available in a timely manner for geoscientists, supporting documentation for these collections might come in the form of a multitude of different charts, photos, tables, and other forms of graphics, such as cross-sections and seismic imagery. Extracting, categorizing, and merging all this disparate information from supporting documentation is very laborious, error prone, and ultimately leads to geoscientists spending long hours prior to working a new opportunity.

### SUMMARY

This Summary is provided to introduce a selection of concepts in a simplified form that are further described below in the Detailed Description. This Summary is not intended to identify key features or essential features of the claimed subject matter.

Aspects of the technology described herein make legacy hydrocarbon studies accessible to modern computer analysis. As used herein, a hydrocarbon study is any document that describes the hydrocarbon environment in a geographic area. A hydrocarbon study may be based on seismic surveys, boreholes, or other analysis. A hydrocarbon study does not need to follow any particular format. In fact, aspects of the technology described herein are able to process hydrocarbon studies in many different formats. A hydrocarbon study can include text, maps, charts, tables, and other features. The maps, charts, tables, and text can all take different forms depending on the author of the study, entity commissioning the study, entity performing the study, and the like. The variety of formats and segments makes computer analysis of the documents challenging since the variety of formats makes meaningful patterns difficult to detect with a high confidence factor.

Many entities have commissioned and collected hydrocarbon studies over a long period of time. Whatever the initial format, the technology described herein analyzes the studies to identify characteristics that are interesting to people who study hydrocarbon environments, particularly for oil and gas exploration. These characteristics are not readily available, and searching for this information, even with the aid of search engines, is a very laborious process. These characteristics are then associated with the document within computer storage. For example, the characteristics may be stored in a relational database or within an index in a search engine for fast retrieval. The characteristics may be used to return the document or a portion of the document, such as a table in the document, in response to a specialized query. The characteristics may also be used to analyze the document acting as input to artificial intelligence models, such as neural networks, decision trees, and the like. The characteristics may be input for analysis along with or instead of the document.

As an initial process, various segments within a hydrocarbon study are identified. The various segments can include specific text sections, maps, charts, and tables. Many different methods have been proposed for what is called document layout analysis (Cattoni, Roldano, et al. “Geometric layout analysis techniques for document image understanding: a review.” ITC-first Technical Report 9703.09 (1998)), but identifying and simply extracting these elements as a different data object, by itself, leads to a data explosion via generating hundreds of segments from a single file. And geoscience data without metadata and labels is often considered useless (National Research Council. 2002. Geoscience Data and Collections: National Resources in Peril. Washington, DC: The National Academies Press. (https://doi.org/10.17226/10348)). Within each of these document segments, specific types of text segments, maps, charts, and tables may be identified. For each segment identified, characteristics of interest may be determined through analysis of the segment. In one aspect, segment-specific analysis is performed on each type of segment. Different technologies may be used for different segments. For example, natural language processing may be used to analyze text segments. Computer Vision models, such as convolutional neural network, may be used to analyze a map. Once the characteristics are identified, they may be stored in association with both the overall document and with a segment of the document from which the characteristic of interest was extracted.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example page from a hydrocarbon study for use with the present disclosure;

FIG. 2 is a diagram depicting an example computing architecture suitable for implementing aspects of the present disclosure;

FIGS. 3-5 are flow diagrams showing exemplary methods of extracting information from a hydrocarbon study, in accordance with one or more aspects of the technology described herein; and

FIG. 6 is a block diagram of an exemplary computing environment suitable for use in implementing aspects of the technology described herein.

### DETAILED DESCRIPTION

The various technology described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Aspects of the technology described herein make legacy hydrocarbon studies accessible to modern computer analysis. As used herein, a hydrocarbon study is any document that describes the hydrocarbon environment in a geographic area. A hydrocarbon study may be based on seismic surveys, boreholes, or other analysis. A hydrocarbon study does not need to follow any particular format. In fact, aspects of the technology described herein are able to process hydrocarbon studies in many different formats. A hydrocarbon study can include text, maps, charts, tables, and other features. The maps, charts, tables, and text can all take different forms depending on the author of the study, entity commissioning the study, entity performing the study, and the like. The variety of formats and segments makes computer analysis of the documents challenging since the variety of formats makes meaningful patterns difficult to detect with a high confidence factor.

Many entities have commissioned and collected hydrocarbon studies over a long period of time. Many of these studies exist only in paper formats that cannot be access by a computer. Without processing, these studies cannot be returned in response to geospatial queries or analyzed through machine learning techniques. In the case of paper studies, the first step may be scanning the study to create a computer file that stores a document image. Other legacy studies may be in a computer searchable format (e.g., non-image) and be associated with various amounts of useful information (e.g., metadata).

Whatever the initial format, the technology described herein analyzes the studies to identify characteristics that are of interest to people who study hydrocarbon environments. These characteristics are then associated with the document within computer storage. For example, the characteristics may be stored in a relational database or within an index in a search engine for fast retrieval. The characteristics may be used to return the document or a portion of the document, such as a table in the document, in response to a query. The characteristics may also be used to analyze the document using one or more artificial intelligence models, such as neural networks, decision trees, and the like. Characteristics of interest include, but are not limited to, publication date of the study, author of the study, location(s) analyzed in the report, a hydrocarbon sentiment, geologic features, geologic age, well reports, the entity commissioning the study, the entity generating a study, and the like.

As an initial process, various segments within a hydrocarbon study are identified. The various segments can include text, maps, charts, and tables. Within each of these segments, specific types of text segments, maps, charts, and tables may be identified. In one aspect, computer vision technology is used to identify these various segments. The computer vision technology can look at the document as an image to identify various segments. Various machine classification technology may alternately be used to look at the content of the document, including textual semantics.

For each segment identified, characteristics of interest may be determined through analysis of the segment. In one aspect, segment-specific analysis is performed on each type of segment. Different technologies may be used for different segments. For example, natural language processing may be used to analyze text segments. Computer Vision models, such as a convolutional neural network, may be used to analyze a map. Once the characteristics are identified, they may be stored in association with both the overall document and with a segment of the document from which the characteristic of interest was extracted. The document and associated characteristics can then be used by other processes, such as queries, machine classification, and the like.

Having briefly described an overview of aspects of the technology described herein, an exemplary operating environment in which aspects of the technology described herein may be implemented is described below in order to provide a general context for various aspects.

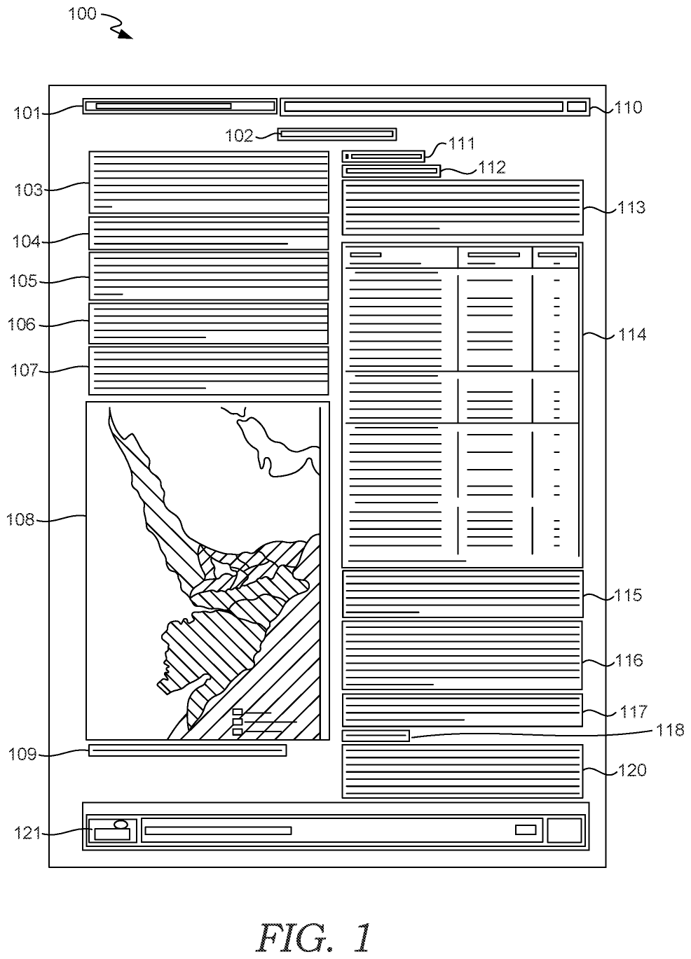

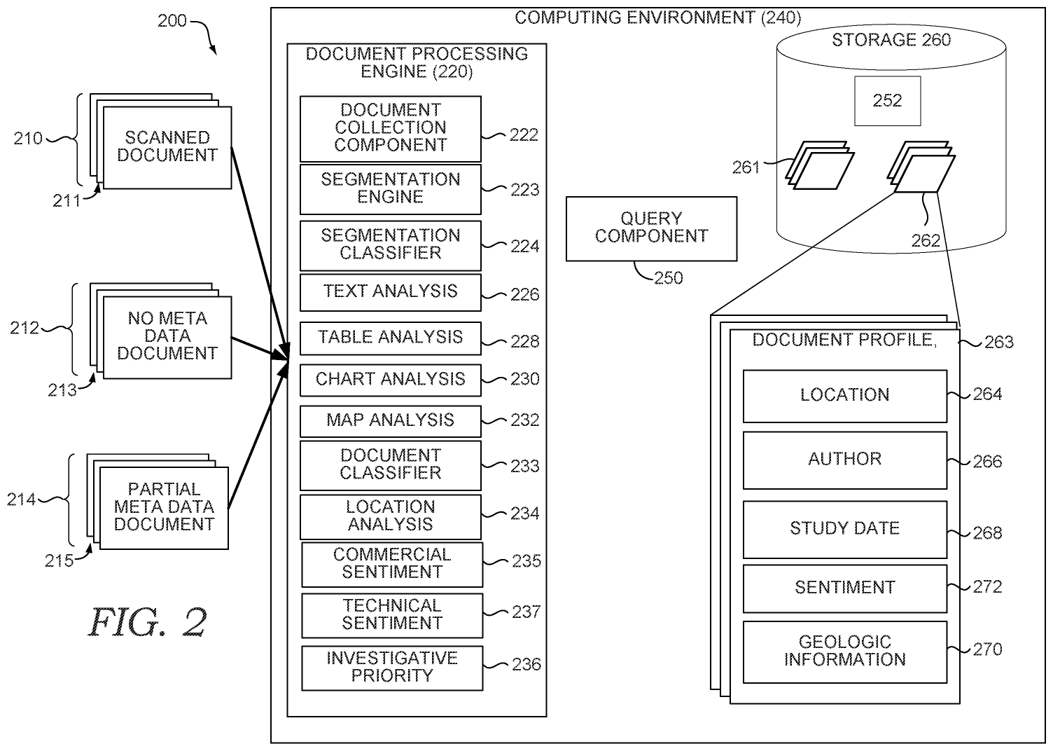

In FIG. 1 an exemplary page 100 of a hydrocarbon study document is shown. A hydrocarbon study could include multiple pages, potentially similar to page 100. As can be seen, the page 100 includes multiple segments, shown as highlighted boxes. The boxes delineate the sections, but are not present in the actual document 100. The text segments include a text segment 101, a text segment 102, a text segment 103, a text segment 104, a text segment 105, a text segment 106, a text segment 107, a text segment 110, a text segment 111, a text segment 112, a text segment 113, a text segment 115, a text segment 116, a text segment 117, a text segment 118, and a text segment 120. The page 100 also includes a table segment 114, a map segment 108, and a map description 109. The map description 109 may be considered to be text associated with the map segment 108 rather than a separate text segment. The graphics bar 121 is another example of a page segment. The text segments can be further categorized. For example, the text segment 110 can be categorized as a document title, the text segment 102 as a subtitle, the text segment 111 as a section heading, and the text segment 112 as a subsection heading. Text segments could be categorized as a title, summary, abstract, conclusion, or other study part. These segments may be identified and classified through an automated analysis, such as the one described subsequently with reference to FIG. 2.

Referring now to FIG. 2, a block diagram is provided showing aspects of an example computing system architecture suitable for analyzing hydrocarbon study documents and designated generally as system 200. System 200 represents only one example of a suitable computing system architecture. Other arrangements and elements can be used in addition to or instead of those shown, and some elements may be omitted altogether for the sake of clarity. Many of the elements described herein are functional entities that may be implemented as discrete or distributed components or in conjunction with other components, and in any suitable combination and location.

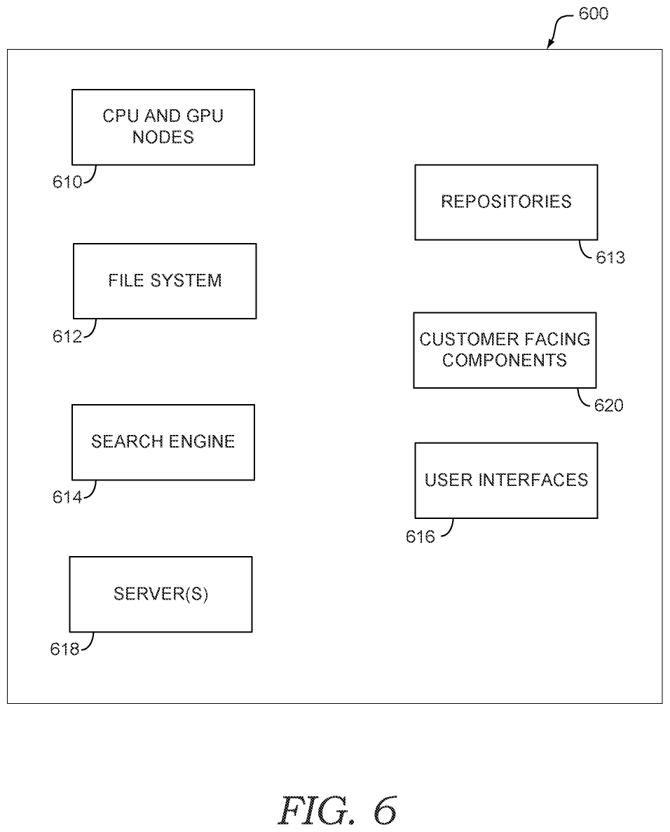

Exemplary system 200 includes computing environment 240, which communicatively couples components of system 200 including document processing engine 220, query component 250, knowledge base 252, and storage 260. Document processing engine 220 (including its components 222, 223, 224, 226, 228, 230, 232, 233, 234, 235, 236, 237), knowledge base 252, and query component 250 may be embodied as a set of compiled computer instructions or functions, program modules, computer software services, or an arrangement of processes carried out on one or more computer systems, such as computing architecture 600 described in connection to FIG. 6, for example.

In one aspect, the functions performed by components of system 200 are associated with one or more applications, services, or routines. In particular, such applications, services, or routines may operate on one or more computing servers, or be implemented in the cloud. Moreover, in some aspects, these components of system 200 may be distributed across a network, including one or more servers, in the cloud, or may reside on a user device, such as a laptop or desktop computer. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein can be performed, at least in part, by one or more hardware logic components. For example, and without limitation, illustrative types of hardware logic components that can be used include Central processing unit (CPUs), Graphics processing unit (GPUs), Field programmable Gate Arrays (FPGAs), etc. Additionally, although functionality is described herein with regards to specific components shown in example system 200, it is contemplated that in some aspects functionality of these components can be shared or distributed across other components.

Continuing with FIG. 2, exemplary system 200 receives documents (e.g., documents 211, 213, or 215) as input at document collection component 222. The system 200 processes hydrocarbon studies, which are often simply called documents within this description. The documents are processed by the document processing engine 220 to identify several different document characteristics of interest. These characteristics may be stored in a document profile 263.

The document profile 263 is an aggregation of metadata stored in different ways, according to the storing and retrieval requirements for each type of information. The document profile comprises attributes that may be associated with one or more values. For example, the publication date attribute may receive a value formatted as a date. Optionally, all or some of the values may be associated with a confidence factor when the value is determined through a machine analysis. As described in more detail, values may be automatically determined through a classifier, natural language processing algorithm, or some other data mining system. Depending on the system used, the result of the determination could be the publication date is 9.16.1972, with a high confidence factor. In this case, both the date 9.16.1972 and the confidence factor (many times not equivalent to a probability), may be recorded. Systems doing subsequent analysis may receive the value and confidence value as inputs.

The processed documents 261 may also be stored within the storage 260. Once processed and stored, various components may use the document profile information to generate a user experience. For example, the query component 250 may return data to a search interface with specialized search inputs. For example, the search interface may include drop down menus to select various geological factors to help form a query. The query interface may allow a user to formulate a query according to attributes of the document profile. For example, the query may specify a geologic age, location, author, geological sentiment, etc. The query component can then return documents that are relevant to the query. The query component 250 may also maintain persisted queries that analyze documents periodically as document profiles are added to the storage 260. When a new document is responsive to the persisted query then one or more users associated with the persisted query may receive a notification.

Three different groups of documents are shown being input to the document collection component 222. These groups illustrate that the system 200 can process a wide variety of documents. The first group of documents 210 are scanned. Generally, document 211 and the other documents in the first group of documents 210 originate as paper documents in a file, library, or some other physical storage. These documents are scanned to create a computer file, and very often do not contain searchable text. The documents may be initially stored as an image in any number of file formats. Optical character recognition may be performed to make text in the document computer searchable.

The second group of documents 212, including document 213, have no metadata that may be directly mapped to a document characteristic of interest. The second group of documents 212 are in a format where the text is computer searchable, such as a Microsoft© Word files and PDFs, rather than an image file. Tables, charts, and maps may be images inserted into the document. The metadata that is associated with the documents may be used in combination with information extracted from the document to determine characteristics of interest. For example, the document may be associated with metadata indicating a date, for example in the document title. However, the significance of the date in the title may be unknown. For example, the date could be when the document was saved, edited, created, or have some other meaning. It is not clear that the date in the title maps to the date the hydrocarbon study was conducted, which is a characteristic of interest. In this case, the date the document was created or saved, as indicated by the date in the title, may not be very close to the publication date.

The third group of documents 214, including document 213, has partial metadata that maps to a characteristics of interest associated with them. For example, the document metadata may reliably indicate a study location, study author, publication date, or other information of interest. The third group of documents 214 are in a format where the text is computer searchable, such as a XML or PDFs with additional metadata, rather than an image file. In the case of an XML, native metadata may be contained in tags, and each XML may be considered a document. The metadata may be used as input to the analysis process and ultimately be the output added to the document profile. The document analysis may proceed independently and then check to see if the content extracted from the document matches the metadata. Differences may be flagged for editorial analysis. Even when the metadata is accurate, the metadata is often unlikely to provide all characteristics of interest. These additional characteristics of interest can be determined through the analysis described subsequently. Thus, the final document profile for an individual document may include attribute values derived from metadata and other attribute values derived from an analysis of the document content.

The document processing engine 220 receives documents and identifies characteristics of interest within the document. The characteristics can be applicable to a segment of the document and/or the document as a whole. For example, a hydrocarbon study may have a publication date and a classification for the overall document. However, a segment of the study may describe a particular area of interest by using a map containing relevant information on rock formations. In this scenario, this segment is still linked to the original document and will inherit its metadata, but will also have metadata that is particular to the specific type of map it refers to. The end result, is a library of document profiles describing characteristics of documents, including characteristics of individual segments of documents, particularly important for oil and gas exploration. The document profile may include links between the characteristics and the portion or segment of the document from which the characteristic was derived. In this way, the user may be able to navigate to a particular portion of a specific document using the document profiles.

The document collection component 222 pulls in documents, such as the document 211, the document 213, or the document 215. Ingesting the document is a starting point for the document processing engine 220. As described previously, the documents input to the system may have different file formats and different amounts of metadata. The document collection component 222 can take several steps to prepare the document for further analysis. For example, when a document 211 is ingested, documents will be converted to multiple images by the segmentation engine 223 just so each image can be classified using the segment classifier 224. This may include image processing techniques to improve image quality, finding convex hulls inside each page, connected component analysis or other steps that work particularly well for low quality scanned documents and images that are montages (an aggregation of multiple other geoscience related images), such as maps, logs, and cross-section. The document collection component 222 may include metadata translation and filtering. Some metadata associated with the document may be filtered out and not used within the document processing engine 220. While other metadata may be used within the document processing engine 220. This metadata may be converted to a common schema for analysis and/or storage. As mentioned, the documents fed to the document collection component 222 can take many different forms including file formats that may store metadata under different attribute headings, character formats, etc. The document collection component 222 can have a conversion function that receives the documents and translates the desired metadata into a schema that is common for all documents processed by the system.

The document collection component 222 may have a queue to store documents temporarily until processed. In another aspect, the document collection component 222 actively retrieves documents from a storage location for processing. In either case, a copy of the document may be processed and ultimately added to the processed documents 261 in the storage 260. The storage 260 can be described as long-term computer storage. Once any preprocessing is completed, the document collection component 222 communicates the document and, optionally, originally associated metadata to the segmentation engine 223.

The segmentation engine 223 identifies different segments within a document, crops these segments and then communicates them to the segment classifier 224, which then classifies the segment according to segment type. The segment types can include text segments, map segments, chart segments, and table segments, as well as their respective subtypes if available. Each of these segments has a different appearance that can be recognized by a properly trained computer vision system. For subtypes, a fusion of natural language process and computer vision can be used.

The segment classifier 224 may use a neural network. As used herein, a neural network comprises at least three operational layers. The three layers can include an input layer, a hidden layer, and an output layer. Each layer comprises neurons. In this particular case, the input layer neurons receive an image of the document and pass data derived from the image to neurons in multiple hidden layers. Neurons in the hidden layers pass on the results of their computations to the additional layer, until the results get to the output layer, generally a softmax layer for multi-classification problems such as image classification. The output layer then produces probability values for each individual segment classification. Different types of layers and networks connect neurons in different ways.

Neurons have an intrinsic activation function that computes its output given an input (e.g., a vector of numbers) that is multiplied by another vector of numbers (called weights). The weights are the adjustable parameters that cause a neural network to produce a correct output given previous known matches between input-output. For example, if the training image showed a map segments then the correct output is to classify the map segment in the image as showing a map. The weights are adjusted during training. Once trained, the weight associated with a given neuron can remain fixed. The other data passing between neurons can change in response to a given input (e.g., document image). Retraining the network with additional training images can update one or more weights in one or more neurons.

The neural network may include many more than three layers. Neural networks with more than one hidden layer may be called deep neural networks. Example neural networks that may be used with aspects of the technology described herein include, but are not limited to, multilayer perceptron (MLP) networks, convolutional neural networks (CNN), recursive neural networks, recurrent neural networks, and long short-term memory (LSTM) (which is a type of recursive neural network). The training implementation described subsequently uses a convolutional neural network, but aspects of the technology are applicable to other types of machine learning.

In each type of deep model, training is used to fit the model output to the training data. In particular, weights associated with each neuron in the model can be updated through training. Originally, the model can comprise random weight values that are adjusted during training. Training in this context is done in multiple iterations, and each iterations comprises multiple steps::forward pass, a loss function calculation and backpropagation, where the weights are updated given mistakes made by the neural network during training. This process is repeated for multiple batches of training images. The goal is to update the weights of each neuron (or other model component) to cause the model to produce an output that maps to the correct segment label for as many images as possible. The training data comprises labeled images. For example, a hydrocarbon study with each segment in the document labeled as a segment of a particular type may serve as training data. The training data may be annotated by humans. Each labeled image is input to the model and used to train it. Once a sufficient number of training images are fed to the model used by segment classifier 224 and the models stops improving or improves slowly during training, then the training can stop. The model can then be used to classify unlabeled images (e.g., not training documents). Upon classification, the segment classifier 224 may communicate various segments to other components for specialized analysis of the segment. For example, the document could be communicated to the text analysis component 226. An individual table could be communicated to the table analysis component 228. The chart analysis component 230 and the map analysis component 232 could likewise receive either the entire document for analysis or the relevant portion. In addition, any metadata associated with the document could be communicated to these specialized analysis components.

The text analysis component 226 may use natural language processing to identify characteristics of interest in different text segments. As mentioned, characteristics of interest include a study location, a study author, a publication date, whether the document was produced internally or externally, and various geologic characteristics, among many others not listed. Various processes may be used to determine these characteristics. In one example, location, dates, and authors can be determined through keyword analysis. Taking dates as an example, the text can be analyzed against a filter developed to identify dates within a text. Dates often take one of a limited number of formats. Once dates are identified, they can be fit using a distribution which helps identifying the most likely date for the study. The exact location of the dates in the document can also be used to tag specific segments with these dates, adding an additional layer of information extraction to this process.

The location analysis may function in a similar way. Initially, words tentatively related to a location may be identified within a text segment. These words may then be compared, leveraging a hierarchical structure for geographic locations, against a knowledge base 252 of known locations. The knowledge base 252 may be specific for use identifying locations found in hydrocarbon studies. For example, the knowledge base 252 may include identification information for various wells, such as well names. The knowledge base 252 may also include descriptions of different geographic formations. In addition, the knowledge base 252 may include political divisions (e.g., cities, counties, countries), geographic features (e.g., rivers, lakes, mountains), transportation features (e.g., train lines, roads), basins, fields, blocks, well names and other information related to a location. Though depicted as a single knowledge base, the knowledge base 252 may be a collection of separate knowledge bases including one or more knowledge bases made available through commercial services.

Location analysis component 234 may assist in identifying a particular location. For example, a single city name may be mentioned in a segment of text. The city name may occur multiple times throughout the world. Without more information the location of the city is ambiguous. The location analysis component 234 can look at other location information mentioned in the segment of text, or possibly surrounding text segments, to disambiguate the city location. For example, if a river name is also mentioned in the text, the text may be associated with an area having both the city name and the river name.

In one aspect, a knowledge base 252 of study authors, publishing entities, commissioning entities, and other values for characteristics of interest is maintained. Keyword analysis may be used to compare words within the text to words within this knowledge base 252. Matches may be noted and used to classify the text segment according to the characteristic. For example, when a proper name in the text segment matches a known author of hydrocarbon studies, then the segment may be associated with the author. At times, a proper name may be found in the text and noted as an individual associated with the text though not as an author. In this way, individuals mentioned in the document may be added to the document profile. The individuals may be associated with a role, such as author, when the role can be determined. Otherwise the name may simply be associated with the document without a role.

The document classifier 233 associates a particular report type to a document, both in terms of scale (basin or well report for instance) and specific content (geochemical reports for example). This component may use a previously defined taxonomy for identifying these documents and a machine learning model that has been trained to identify documents that conform to the defined taxonomy and has other particular characteristics.

The sentiment analysis components, commercial sentiment analysis 235 and technical sentiment analysis 237, can perform sentiment analysis from a technical and commercial perspective in respect to hydrocarbon systems. Natural Language Processing and Machine Learning techniques may be employed to assign sentiments to the text segments. A sentiment may be positive, negative, or neutral regarding a particular object, such as the presence of hydrocarbons in a geologic formation, the economic viability of extracting the hydrocarbons, the political viability of obtaining drilling rights, or the like.

In various implementations, the text segment may be analyzed using natural language processing to assess the sentiments of the text. The analysis may identify both the sentiment and the object of the sentiment. The natural language processing algorithm may employ at least one lexical dictionary specific to hydrocarbon studies. The lexical dictionary comprises associations between designated expressive symbols and designated sentiments (e.g. positive, negative) as entries therein. The designated expressive symbols can correspond to characters, words, and phrases that are indicative of one or more sentiments that are typically present in a hydrocarbon study. It is noted that the same expressive symbol can optionally have multiple entries in lexical dictionary, which can be selected from based on surrounding parts of speech and content in the text.

Sentiment assignments may consider multiple expressive symbols and multiple associated designated sentiments, as well as any other words in the text, which may be structured in a parse tree, and metadata, to arrive at one or more sentiments. Herein, indicated associations between text and sentiments are generally referred to as sentiment indicators. Entries in lexical dictionary correspond to some sentiment indicators, which can be used to assign sentiments to text. For example, the words “dry hole” may be a negative sentiment indicator specific to a hydrocarbon study. When found in a text segment “dry hole” may be used to assign a negative sentiment towards the presence of hydrocarbons. Source Rock associated to specific geological ages, such as the Cretaceous or the Jurassic time period may be considered positive. In terms of commerciality, “farm-ins unavailable”, “government instability” and “lack infrastructure” all point to negative commercial sentiment.

The table analysis component 228 identifies the type of table depicted and characteristics of interest for the table. Hydrocarbon studies may include various types of tables. Commonly found tables include PVT (pressure-volume-temperature), geochemical analysis, mud logging, and the like. The type of table can be classified using a combination of natural language processing and computer vision techniques, such as those used to identify tables in the first place. The training data can be labeled tables of different types. In one aspect, the table is classified by performing text extraction on the column labels, row labels, table title, and other text associated with the table. This information could be fed to a neural network or other machine classification engine in order to recognize the table type.

The table analysis component 228 can determine characteristics of interest from the table. For example, row or column headings may describe locations, such as exploration wells. These exploration wells can be mapped to a geographic location using the knowledge base 252. The geographic location can then be associated with the table. The table may also describe various geologic characteristics. For example, the depth of different strata may be described in some tables. Extracting this data requires an understanding of the table as whole. A depth number in a column may be mapped to the strata described in the row heading in order to determine the characteristic of interest (e.g., strata depth). These characteristics could be extracted and added to the profile of the particular table.

The table may be processed in a way that maintains its structure. In other words, a number depicted in the table can be maintained in a proper association with its row and column context. Maintaining the structure of the table and identifying what type of information is in the table may allow for sentiment analysis. For example, hydrocarbon quantities found in a test well may be interpreted to have a positive or negative sentiment. The table analysis component 228 can be trained to recognize these ranges and assign a hydrocarbon sentiment to the table based on them. Because the table may depict results from multiple locations (e.g., wells) an individual table may serve as source of information for multiple different wells.

The chart analysis component 230 identifies different chart types and extracts characteristics of interest from those charts. In particular, hydrocarbon studies often include charts of seismic analysis. Bar graphs, line graphs, pie charts, and other charts are also common. As with the table, text shown on or surrounding a chart may be analyzed for characteristics of interest, such as location, study date, or other information. Image processing algorithms coupled with Computer Vision models, such as a convolutional neural network, may be trained to identify a sentiment within a chart. Text extracted from annotated charts may be used to indicating positive, neutral, or negative sentiments towards the presence of hydrocarbon indicated by the chart.

The map analysis component 232 identifies one or more locations indicated on a map. In one aspect, the map analysis component 232 determines a central geographic location of a map. The central geographic location can then be used to help overlay an image of the map on a digital map of an area. For example, a map may depict cities, wells, rivers and other geographic features typically found on a map. The map can also include hydrocarbon specific features, such as lines indicating where a seismic analysis or other study took place. The presence of a seismic line on a map is one example of a characteristic of interest that could be identified and noted in the map profile. Location information can also be extracted and added to the profile.

The location analysis component 234 may help determine the central location depicted on a map. The first step can be determining information on map that is useful for locating the map in the world. For example, cities, roads, rivers, lakes, wells, and other features with a known geo-location (e.g., latitude and longitude) are identified through textual and image analysis of words depicted on a map. Depending on the type of map, the actual location of these words in the real-world (instead of location on the map) is used to determine the central point of the map by building a model that includes these features. In other cases, the algorithm considers the location of words in the image, as well as additional characteristics of each word, such as font size, to determine the most likely center point for the map. For certain maps, the features can even be used to aid the process of rubber-sheeting these maps on a globe map. For example, if the real distance between two cities on a map is 50 miles and the cities are 200 pixels apart, then the map scale is roughly 4 pixels per mile. This scale can be used to determine the area covered by the map. The cities can then be located within the map area using the cities actual coordinates and then used to determine the center of the map area. The distances between features and their relative location to one-another is then used to identify a central location of the map. The central location may be recorded as part of the metadata associated to this segment, stored in document profile 263.

The investigative priority component 236 can process the output of the other components to determine an investigative priority of a document. The investigative priority component may use a machine learning model or weighting algorithm to determine whether further investigation of the study should be prioritized. In particular, the investigative priority component 236 can be trained to properly prioritize documents, when displaying them to geoscientists, with negative and positive hydrocarbon indicators data mined using the other components within the document processing engine. The investigative priority can also be associated with the document profile 263.

Once the analysis of the documents is completed by the document processing engine 220, a summary of the findings may be sent to the storage 260. The storage can include a plurality of document profiles 262 along with the processed documents 261. The document profile 263 is one example of a document profile showing just some of the information that could be included. As mentioned, each segment in a document may have its own profile with similar information. The document profile 263 can include location information 264, author information 266, study date 268, a geologic information 270, and a sentiment 272. Example geologic information includes geologic age range, key phrases describing important geological structures and depth associated to specific elements such as cores and source rock samples.

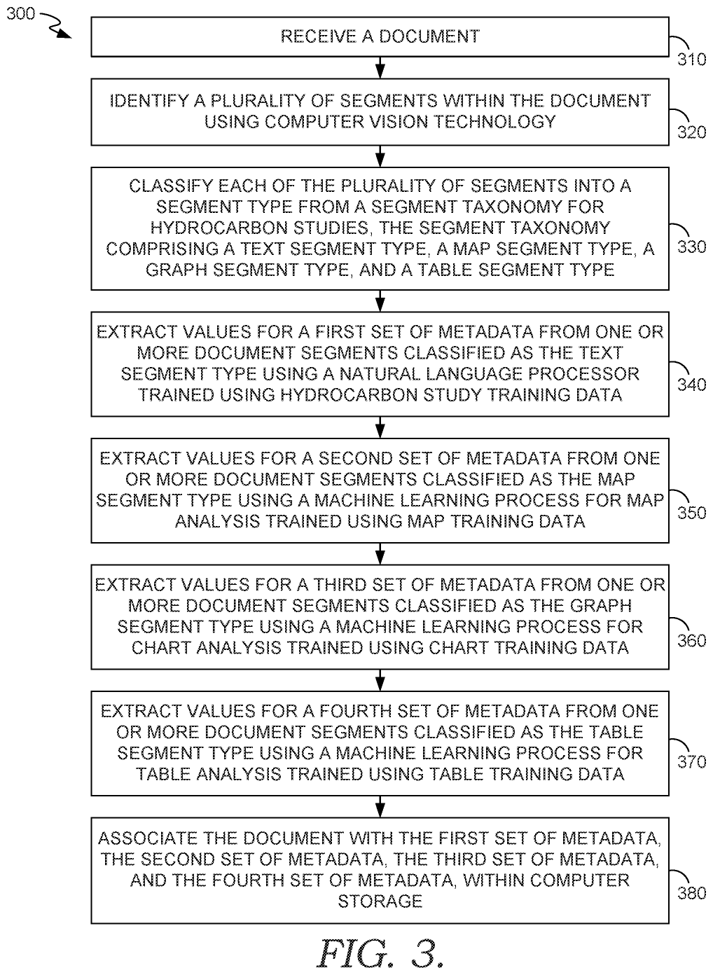

Turning now to FIG. 3, a method 300 of extracting information from a hydrocarbon study is provided. Method 300 could be performed by the document processing engine 220 or similar component. Method 300 may be performed using one or more computing devices.

At step 310, a document is received. The document may be received in any number of possible formats. The document may be received in any number of possible formats. The document may go through pre-processing. For example, if the document is not in a computer-readable image format used by a machine vison system, then the document may be converted to an image format used to identify and classify document segments.

At step 320, a plurality of segments within the document is identified using computer vision technology. The identification of segments has been described with reference to the document collection component 222.

At step 330, each of the plurality of segments are classified into a segment type from a segment taxonomy for hydrocarbon studies. The segment taxonomy comprises a text segment type, a map segment type, a graph segment type, and a table segment type. The classification of segments has been described with reference to the document collection component 222.

At step 340, values for a first set of metadata are extracted from one or more document segments classified as the text segment type using a natural language processor trained using hydrocarbon study training data. The first set of metadata comprises data attributes selected from a group consisting of location information, document creation date information, document author information, geologic formation information, and hydrocarbon sentiment information. Other metadata is also possible. Multiple values may be extracted for a single attribute. For example, multiple locations may be associated with a document. Text analysis, including sentiment analysis has been described previously with reference to FIG. 3.

At step 350, values for a second set of metadata are extracted from one or more document segments classified as the map segment type using a machine learning process for map analysis trained using map training data. The second set of metadata comprising the data attributes selected from the group consisting of location information, document creation date information, document author information, geologic formation information, and hydrocarbon sentiment information. Other metadata is also possible. Multiple values may be extracted for a single attribute. For example, multiple locations may be associated with a map. Map analysis, including determining its correct location has been described previously with reference to FIG. 3.

At step 360, values for a third set of metadata are extracted from one or more document segments classified as the graph segment type using a machine learning process for chart analysis trained using chart training data. The third set of metadata comprising the data attributes selected from the group consisting of location information, document creation date information, document author information, geologic formation information, and hydrocarbon sentiment information. Other metadata is also possible. Multiple values may be extracted for a single attribute. For example, multiple locations may be associated with a chart. Chart analysis, including sentiment analysis has been described previously with reference to FIG. 3.

At step 370, values for a fourth set of metadata are extracted from one or more document segments classified as the table segment type using a machine learning process for table analysis trained using table training data. The fourth set of metadata comprising the data attributes selected from the group consisting of location information, document creation date information, document author information, geologic formation information, and hydrocarbon sentiment information. Other metadata is also possible. Multiple values may be extracted for a single attribute. For example, multiple locations may be associated with a table. Table analysis, including sentiment analysis has been described previously with reference to FIG. 3.

At step 380, the document is associated with the first set of metadata, the second set of metadata, the third set of metadata, and the fourth set of metadata, within computer storage. For example, the metadata could be stored in a vector or other data structure.

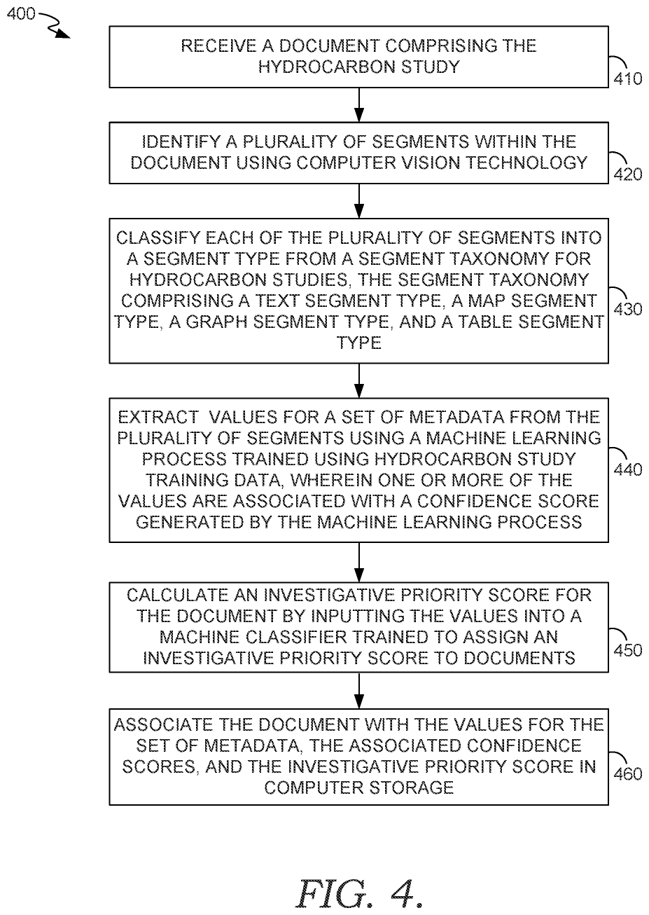

Turning now to FIG. 4, a method 400 of extracting information from a hydrocarbon study is provided. Method 400 could be performed by the document processing engine 220 or similar component. Method 400 may be performed using one or more computing devices.

At step 410, a document comprising the hydrocarbon study is received. The document may be received in any number of possible formats. The document may go through pre-processing. For example, if the document is not in a computer-readable image format used by a machine vison system, then the document may be converted to an image format used to identify and classify document segments.

At step 420, a plurality of segments within the document is identified using computer vision technology. The identification of segments has been described with reference to the document collection component 222.

At step 430, each of the plurality of segments is classified into a segment type from a segment taxonomy for hydrocarbon studies. The segment taxonomy comprises a text segment type, a map segment type, a graph segment type, and a table segment type, among sub classifications that may exist for each of the high level categories. A confidence factor may be associated with each piece of the metadata extracted, so subsequent algorithms or queries can take use the metadata in further operations. The classification of segments has been described with reference to the document collection component 222.

At step 440, values for a set of metadata are extracted from the plurality of segments using a machine learning process trained using hydrocarbon study training data. The set of metadata comprises data attributes selected from a group consisting of location information, document creation date information, document author information, geologic age information, information about the origin of the document (internal or external), and hydrocarbon sentiment information. Different types of segments could be analyzed with segment-type specific tools, as described previously. In an aspect, one or more of the values are associated with a confidence score generated by the machine learning process. For example, the confidence score can indicate a confidence that a location value assigned to a location metadata field is correct.

At step 450, an investigative priority score for the document is calculated by inputting the set of metadata into a machine classifier trained to assign an investigative priority score to a document. The investigative priority score has been described previously with reference to FIG. 3.

At step 460, the document is associated with the set of metadata values, the corresponding confidence factors, and the investigative priority score in computer storage. For example, the metadata and investigative priority score could be stored in an in-memory tree structure acting as an index or other data structure.

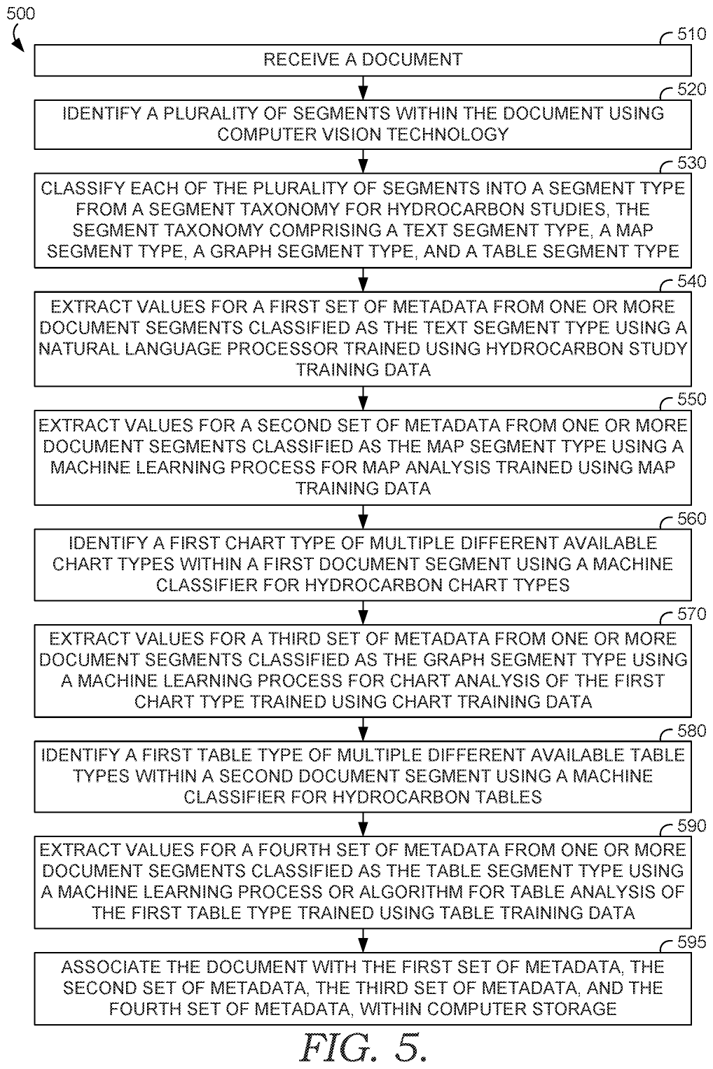

Turning now to FIG. 5, a method 500 of extracting information from a hydrocarbon study is provided. Method 500 could be performed by the document processing engine 220 or similar component. Method 500 may be performed using one or more computing devices.

At step 510, a document is received. The document may be received in any number of possible formats. The document may go through pre-processing. For example, if the document is not in a computer-readable image format used by a machine vison system, then the document may be converted to an image format used to identify and classify document segments.

At step 520, a plurality of segments within the document is identified using computer vision technology. The identification of segments has been described with reference to the document collection component 222.

At step 530, each of the plurality of segments are classified into a segment type from a segment taxonomy for hydrocarbon studies. The segment taxonomy comprises a text segment type, a map segment type, a graph segment type, and a table segment type. The classification of segments has been described with reference to the document collection component 222.

At step 540, values for a first set of metadata are extracted from one or more document segments classified as the text segment type using a natural language processor trained using hydrocarbon study training data. The first set of metadata comprises data attributes selected from a group consisting of location information, document creation date information, document author information, geologic formation information, and hydrocarbon sentiment information. Other metadata is also possible. Multiple values may be extracted for a single attribute. For example, multiple locations may be associated with a document. Text analysis, including sentiment analysis has been described previously with reference to FIG. 3.

At step 550, values for a second set of metadata are extracted from one or more document segments classified as the map segment type using a machine learning process for map analysis trained using map training data. The second set of metadata comprising the data attributes selected from the group consisting of location information, document creation date information, document author information, geologic formation information, and hydrocarbon sentiment information. Other metadata is also possible. Multiple values may be extracted for a single attribute. For example, multiple locations may be associated with a map. Map analysis, including determining is correct location as described previously with reference to FIG. 3.

At step 560, a first chart type, of multiple different available chart types, is identified within a first document segment using a machine classifier for hydrocarbon chart types. The different charts could be identified by training a neural network, or other machine classification system, to identify visual features of different charts, textual headings on different axis, and data ranges.

At step 570, values for a third set of metadata are extracted from one or more document segments classified as the graph segment type using a machine learning process for chart analysis of the first chart type trained using chart training data. The third set of metadata the comprising data attributes selected from the group consisting of location information, document creation date information, document author information, geologic formation information, and hydrocarbon sentiment information. Other metadata is also possible. Multiple values may be extracted for a single attribute. For example, multiple locations may be associated with a chart. Chart analysis, including sentiment analysis has been described previously with reference to FIG. 3.

At step 580, a first table type, of multiple different available table types, is identified within a second document segment using a machine classifier for hydrocarbon tables. The different tables could be identified by training a neural network, or other machine classification system to identify visual features of different tables, textual headings on different tables, row headings, and data ranges.

At step 590, values for a fourth set of metadata are extracted from one or more document segments classified as the table segment type using a machine learning process tuned for table analysis of the first table type trained using table training data. The fourth set of metadata comprising the data attributes selected from the group consisting of location information, document creation date information, document author information, geologic formation information, and hydrocarbon sentiment information. Other metadata is also possible. Multiple values may be extracted for a single attribute. For example, multiple locations may be associated with a table. Table analysis, including sentiment analysis has been described previously with reference to FIG. 3.

At step 595, the document is associated with the first set of metadata, the second set of metadata, the third set of metadata, and the fourth set of metadata, within computer storage. For example, the metadata could be stored in a vector or other data structure.

Referring to the drawings in general, and initially to FIG. 6 in particular, an exemplary operating environment for implementing aspects of the technology described herein is shown and designated generally as computing architecture 600. Computing architecture 600 is but one example of a suitable computing environment and is not intended to suggest any limitation as to the scope of use of the technology described herein. Neither should this architecture be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant, smart phone, tablet, or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices located on a vehicle, vehicle telematics devices, etc. Aspects of the technology described herein may also be practiced in distributed computing environments where tasks are performed by remote-processing devices that are linked through a communications network.

With continued reference to FIG. 6, a high-level computing architecture 600 includes a cluster CPU and GPU nodes 610, an scalable file system 612, a search engine 614, an API layer for minor data restructuring and serving data to the user interface 616 and additional servers 618 to host customer facing components 620. Although the various blocks of FIG. 6 are shown with lines for the sake of clarity, in reality, delineating various components is not so clear, and metaphorically, the lines would more accurately be grey and fuzzy.

Computing architecture 600 typically includes a variety of computer-readable media. Computer-readable media can be any available media that can be accessed by computing architecture 600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory and hundreds of terabytes in the form of persistent data storage such as HDDs and SSDs or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, cellular, Bluetooth, Wi-Fi, NFC, infrared, and other wireless media. Combinations of any of the above should also be included within the scope of computer-readable media.

Scalable file system 612 refers to middleware responsible for distributing write/read data load across multiple disks when the infrastructure is meant to store petabytes of information. In these situation, special software is required to make this array of disks seem like a single repository of information that can store petabytes instead of the few terabytes singles disks can store.

Repositories 613 can take many forms, from structured flat files to SQL and No-SQL databases. The image, metadata and layer repositories have different data models and use different technologies in accordance to indexing and response time requirements for each specific data type.

Servers 618 can be multi-processor machines with terabytes of disk space and hundreds of gigabytes, or a handful of terabytes, of RAM memory. Theses servers might be distributed across the network, and considerations around latency given their physical location applies when designing for low response times and reliability.

APIs (Application Programming Interface) act as abstraction layers among different systems. For example, when two different applications interact, A and B, usually the data provided by application A does not conform to what is expected by application B. They can be used as a way to meet additional data structure requirements for application B, without the need to changing any functionality in application A. APIs are also commonly used as a way to decouple the User Interface 616 from the other parts of the system.

### Embodiments

EMBODIMENT 1. A method of extracting relevant information from a hydrocarbon study, comprising: receiving a document; identifying a plurality of segments within the document using computer vision technology; classifying each of the plurality of segments into a segment type from a segment taxonomy for hydrocarbon studies, the segment taxonomy comprising a text segment type, a map segment type, a graph segment type, and a table segment type; extracting values for a first set of metadata from one or more document segments classified as the text segment type using a natural language processor trained using hydrocarbon study training data, the first set of metadata comprising data attributes selected from a group consisting of location information, document creation date information, document author information, geologic formation information, and hydrocarbon sentiment information; extracting values for a second set of metadata from one or more document segments classified as the map segment type using a machine learning process for map analysis trained using map training data, the second set of metadata comprising the data attributes selected from the group consisting of location information, document creation date information, document author information, geologic formation information, and hydrocarbon sentiment information; extracting values for a third set of metadata from one or more document segments classified as the graph segment type using a machine learning process for chart analysis trained using chart training data, the third set of metadata comprising the data attributes selected from the group consisting of location information, document creation date information, document author information, geologic formation information, and hydrocarbon sentiment information; extracting values for a fourth set of metadata from one or more document segments classified as the table segment type using a machine learning process for table analysis trained using table training data, the fourth set of metadata comprising the data attributes selected from the group consisting of location information, document creation date information, document author information, geologic formation information, and hydrocarbon sentiment information; and associating the document with the first set of metadata, the second set of metadata, the third set of metadata, and the fourth set of metadata, within computer storage.

EMBODIMENT 2. The method of embodiment 1, wherein the computer storage is a combination of structured flat files on disk, a search engine, SQL and No-SQL databases.

EMBODIMENT 3. The method as in any one of the preceding embodiments, further comprising: receiving a query comprising location information that matches a value in the first set of metadata; and returning a search result identifying the document in response to the query.

EMBODIMENT 4. The method as in any one of the preceding embodiments, further comprises determining a map segment's geolocation with a heuristic that uses a taxonomy of valid locations, placement of words denoting different geographical entities on the map segment and the entities real relative location on the globe, size of fonts used for the words, map outlines and text segments that were originally near the map cropped out of the document.

EMBODIMENT 5. The method as in any one of the preceding embodiments, wherein the hydrocarbon study training data comprises labeled text associated with a description of collocated words that are associated with positive and negative sentiment for various components of a working hydrocarbon system.

EMBODIMENT 6. The method as in any one of the preceding embodiments, wherein the hydrocarbon sentiment information comprises an indication whether a farm-in, bid on a block, revising an old acreage and ultimately drilling is recommended.

EMBODIMENT 7. The method as in any one of the preceding embodiments, wherein the chart training data comprises annotated two-dimensional seismic line images, PVT plots, among others.

EMBODIMENT 8. A method of extracting information from a hydrocarbon study, comprising: receiving a document comprising the hydrocarbon study; identifying a plurality of segments within the document using computer vision technology; classifying each of the plurality of segments into a segment type from a segment taxonomy for hydrocarbon studies, the segment taxonomy comprising a text segment type, a map segment type, a graph segment type, and a table segment type; extracting values for a set of metadata from the plurality of segments using a machine learning process trained using hydrocarbon study training data, the set of metadata comprising data attributes selected from a group consisting of location information, document creation date information, document author information, geologic formation information, and hydrocarbon sentiment information, wherein one or more of the values are associated with a confidence score generated by the machine learning process; calculating an investigative priority score for the document by inputting the values into a machine classifier trained to assign investigative priority scores to documents; and associating the document with the values for the set of metadata, the confidence scores for each machine created metadata, and the investigative priority score in computer storage.

EMBODIMENT 9. The method as embodiment 8, wherein the method further comprises communicating an alert to a designated user when the investigative priority score is within a threshold range associated with a high priority.

EMBODIMENT 10. The method as in any one of embodiments 8 and 9, further comprising: receiving a query comprising a location information and an accepted confidence score range; determining the location information matches a value in a location metadata field within the set of metadata and the confidence score for the value in the location metadata field is within the confidence score range; and returning a search result identifying the document in response to the query.

EMBODIMENT 11. The method as in any one of embodiments 8, 9, and 10, further comprising using a process that is a fusion of natural language processing and computer vision to identify probable locations for a geographic center of a map image.

EMBODIMENT 12. The method as in any one of embodiments 8, 9, 10, and 11, wherein the hydrocarbon study training data comprises labeled text associated with a description of collocated words that are associated with positive and negative sentiment for various components of a working hydrocarbon system.

EMBODIMENT 13. The method as in any one of embodiments 8, 9, 10, 11, and 12, wherein the hydrocarbon study training data comprises labeled text associated with different examples describing types of investigative work performed and the labeled text is linked to a scope of analysis sentiment.

EMBODIMENT 14. The method as in any one of embodiments 8, 9, 10, 11, 12, and 13, wherein the location information includes well identification information.

EMBODIMENT 15. A method of extracting information from a hydrocarbon study comprising: receiving a document; identifying a plurality of segments within the document using computer vision technology; classifying each of the plurality of segments into a segment type from a segment taxonomy for hydrocarbon studies, the segment taxonomy comprising a text segment type, a map segment type, a graph segment type, and a table segment type; extracting values for a first set of metadata from one or more document segments classified as the text segment type using a natural language processor trained using hydrocarbon study training data, the first set of metadata comprising data attributes selected from a group consisting of location information, document creation date information, document author information, geologic formation information, and hydrocarbon sentiment information; extracting values for a second set of metadata from one or more document segments classified as the map segment type using a machine learning process for map analysis trained using map training data, the second set of metadata comprising data attributes selected from the group consisting of location information, document creation date information, document author information, geologic formation information, and hydrocarbon sentiment information; identifying a first chart type of multiple different available chart types within a first document segment using a machine classifier for hydrocarbon chart types; extracting values for a third set of metadata from one or more document segments classified as the graph segment type using a machine learning process for chart analysis of the first chart type trained using chart training data, the third set of metadata comprising data attributes selected from the group consisting of location information, document creation date information, document author information, geologic formation information, and hydrocarbon sentiment information; identifying a first table type of multiple different available table types within a second document segment using a machine classifier for hydrocarbon tables; extracting values for a fourth set of metadata from one or more document segments classified as the table segment type using a machine learning process or particular algorithm for table analysis of the first table type trained using table training data, the fourth set of metadata comprising data attributes selected from the group consisting of location information, document creation date information, document author information, geologic formation information, and hydrocarbon sentiment information; and associating the document with the first set of metadata, the second set of metadata, the third set of metadata, and the fourth set of metadata, within computer storage.

EMBODIMENT 16. The method of embodiment 15, wherein machine learning processes for different table types are available and wherein machine learning processes for different chart types are available.

EMBODIMENT 17. The method as in any one of embodiments 15 and 16, further comprising using a process that is a fusion of natural language processing and computer vision to identify probable locations for a geographic center of a map image.

EMBODIMENT 18. The method as in any one of embodiments 15, 16 and 17, wherein the location information includes country, basin, block, field and well identification information.

EMBODIMENT 19. The method as in any one of embodiments 15, 16, 17 and 18, wherein the hydrocarbon study training data comprises labeled text associated with a description of collocated words that are associated with positive and negative sentiment for various components of a working hydrocarbon system.

EMBODIMENT 20. The method as in any one of embodiments 15, 16, 17, 18 and 19, wherein a fusion of natural language processing and computer vision models may be used to identify a subclass for a particular segment type.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

1. A method of extracting relevant information from a hydrocarbon study, comprising:
receiving a document;
identifying a plurality of segments within the document using computer vision technology;
classifying each of the plurality of segments into a segment type from a segment taxonomy for hydrocarbon studies, the segment taxonomy comprising a text segment type, a map segment type, a graph segment type, and a table segment type;
extracting values for a first set of metadata from one or more document segments classified as the text segment type using a natural language processor trained using hydrocarbon study training data, the first set of metadata comprising data attributes selected from a group consisting of location information, document creation date information, document author information, geologic formation information, and hydrocarbon sentiment information;
extracting values for a second set of metadata from one or more document segments classified as the map segment type using a machine learning process for map analysis trained using map training data, the second set of metadata comprising the data attributes selected from the group consisting of location information, document creation date information, document author information, geologic formation information, and hydrocarbon sentiment information;
extracting values for a third set of metadata from one or more document segments classified as the graph segment type using a machine learning process for chart analysis trained using chart training data, the third set of metadata comprising the data attributes selected from the group consisting of location information, document creation date information, document author information, geologic formation information, and hydrocarbon sentiment information;
extracting values for a fourth set of metadata from one or more document segments classified as the table segment type using a machine learning process for table analysis trained using table training data, the fourth set of metadata comprising the data attributes selected from the group consisting of location information, document creation date information, document author information, geologic formation information, and hydrocarbon sentiment information; and associating the document with the first set of metadata, the second set of metadata, the third set of metadata, and the fourth set of metadata, within computer storage.

2. The method of claim 1, wherein the computer storage is a combination of structured flat files on disk, a search engine, SQL and No-SQL databases.

3. The method of claim 1, further comprising:
receiving a query comprising location information that matches a value in the first set of metadata; and
returning a search result identifying the document in response to the query.

4. The method of claim 1, further comprises determining a map segment's geolocation with a heuristic that uses a taxonomy of valid locations, placement of words denoting different geographical entities on the map segment and the entities real relative location on the globe, size of fonts used for the words, map outlines and text segments that were originally near the map cropped out of the document.

5. The method of claim 1, wherein the hydrocarbon study training data comprises labeled text associated with a description of collocated words that are associated with positive and negative sentiment for various components of a working hydrocarbon system.

6. The method of claim 1, wherein the hydrocarbon sentiment information comprises an indication whether a farm-in, bid on a block, revising an old acreage and ultimately drilling is recommended.

7. The method of claim 1, wherein the chart training data comprises one or more of annotated two-dimensional seismic line images and PVT plots.

8. A method of extracting information from a hydrocarbon study, comprising:
receiving a document comprising the hydrocarbon study;
identifying a plurality of segments within the document using computer vision technology;
classifying each of the plurality of segments into a segment type from a segment taxonomy for hydrocarbon studies, the segment taxonomy comprising a text segment type, a map segment type, a graph segment type, and a table segment type;
extracting values for a set of metadata from the plurality of segments using a machine learning process trained using hydrocarbon study training data, the set of metadata comprising data attributes selected from a group consisting of location information, document creation date information, document author information, geologic formation information, and hydrocarbon sentiment information, wherein one or more of the values are associated with a confidence score generated by the machine learning process;
calculating an investigative priority score for the document by inputting the values into a machine classifier trained to assign investigative priority scores to documents; and
associating the document with the values for the set of metadata, the confidence scores for each machine created metadata, and the investigative priority score in computer storage.

9. The method of claim 8, wherein the method further comprises communicating an alert to a designated user when the investigative priority score is within a threshold range associated with a high priority.

10. The method of claim 8, further comprising:
receiving a query comprising a location information and an accepted confidence score range;
determining the location information matches a value in a location metadata field within the set of metadata and the confidence score for the value in the location metadata field is within the confidence score range; and
returning a search result identifying the document in response to the query.

11. The method of claim 8, further comprising using a process that is a fusion of natural language processing and computer vision to identify probable locations for a geographic center of a map image.

12. The method of claim 8, wherein the hydrocarbon study training data comprises labeled text associated with a description of collocated words that are associated with positive and negative sentiment for various components of a working hydrocarbon system.

13. The method of claim 8, wherein the hydrocarbon study training data comprises labeled text associated with different examples describing types of investigative work performed and the labeled text is linked to a scope of analysis sentiment.

14. The method of claim 8, wherein the location information includes well identification information.

15. A method of extracting information from a hydrocarbon study comprising:
receiving a document;
identifying a plurality of segments within the document using computer vision technology;
classifying each of the plurality of segments into a segment type from a segment taxonomy for hydrocarbon studies, the segment taxonomy comprising a text segment type, a map segment type, a graph segment type, and a table segment type;
extracting values for a first set of metadata from one or more document segments classified as the text segment type using a natural language processor trained using hydrocarbon study training data, the first set of metadata comprising data attributes selected from a group consisting of location information, document creation date information, document author information, geologic formation information, and hydrocarbon sentiment information;
extracting values for a second set of metadata from one or more document segments classified as the map segment type using a machine learning process for map analysis trained using map training data, the second set of metadata comprising data attributes selected from the group consisting of location information, document creation date information, document author information, geologic formation information, and hydrocarbon sentiment information;
identifying a first chart type of multiple different available chart types within a first document segment using a machine classifier for hydrocarbon chart types;
extracting values for a third set of metadata from one or more document segments classified as the graph segment type using a machine learning process for chart analysis of the first chart type trained using chart training data, the third set of metadata comprising data attributes selected from the group consisting of location information, document creation date information, document author information, geologic formation information, and hydrocarbon sentiment information;
identifying a first table type of multiple different available table types within a second document segment using a machine classifier for hydrocarbon tables;
extracting values for a fourth set of metadata from one or more document segments classified as the table segment type using a machine learning process or particular algorithm for table analysis of the first table type trained using table training data, the fourth set of metadata comprising data attributes selected from the group consisting of location information, document creation date information, document author information, geologic formation information, and hydrocarbon sentiment information; and
associating the document with the first set of metadata, the second set of metadata, the third set of metadata, and the fourth set of metadata, within computer storage.

16. The method of claim 15, wherein machine learning processes for different table types are available and wherein machine learning processes for different chart types are available.

17. The method of claim 15, further comprising using a process that is a fusion of natural language processing and computer vision to identify probable locations for a geographic center of a map image.

18. The method of claim 15, wherein the location information includes country, basin, block, field and well identification information.

19. The method of claim 15, wherein the hydrocarbon study training data comprises labeled text associated with a description of collocated words that are associated with positive and negative sentiment for various components of a working hydrocarbon system.

20. The method of claim 15, wherein a fusion of natural language processing and computer vision models may be used to identify a subclass for a particular segment type.

21. A non-transitory computer readable medium having stored thereon software instructions that, when executed by a processor, cause the processor to perform the method of claim 1.

22. A system comprising a processor and memory, the processor in communication with the memory, the memory having stored thereon software instructions that, when executed by the processor, cause the processor to perform the method of claim 1.
